(19) United States
(12) Patent Application Publication
(10) Pub. No.: US 2026/0230354 A1
(43) Pub. Date: Aug. 6, 2026

(54) PEER CAPABILITY DETECTION FOR EXTENDED LINK TRAINING

(71) Applicant: NVIDIA Corporation, Santa Clara, CA (US)

(72) Inventors: Stanislav Gurtovoy, Nesher (IL); Leon Bruckman, Petah Tikva (IL); Guy Lederman, Ness Ziona (IL); Gil Golan, Netanya (IL); Zvi Rechtman, Petah-Tikva (IL)

(21) Appl. No.: 19/042,512

(22) Filed: Jan. 31, 2025

(51) Int. Cl. H04L 25/03; H04L 7/04

(52) U.S. Cl. CPC H04L 25/03878; H04L 7/04

(57) ABSTRACT

A method includes inverting a polarity of a wired connection that couples a first peer device to a second peer device and reverting the polarity of the wired connection. Based on the inverting and the reverting of the wired connection, determining that the first peer device and the second peer device share a capability.

### TECHNICAL FIELD

At least one embodiment pertains to peer capability detection over a wired connection.

### BACKGROUND

In many communication systems, devices often have both compatible and incompatible capabilities that affect how they collaborate. If one peer device initiates a feature that the other device does not support, the operation may fail, performance could deteriorate, or resources might be wasted. Accordingly, peer devices commonly employ detection mechanisms to determine which capabilities they share. By identifying overlapping capabilities, these peer devices can coordinate more reliably and use resources more efficiently.

### BRIEF DESCRIPTION OF THE DRAWINGS

FIG. 1 illustrates a network with a peer transmitter and a peer receiver with capability detection logic, according to one embodiment.

FIG. 2 is a flowchart illustrating a method of detecting a capability within a peer device, according to one embodiment.

FIG. 3A is a flowchart illustrating a method of a capability detection process performed by a responding peer device coupled to a signaling peer device by an Ethernet® connection.

FIG. 3B is a flowchart illustrating a method of the capability detection process performed by the signaling peer device.

FIG. 4 illustrates a timeline of communication and actions between a requesting peer device and a responding peer device that each support enhanced link training, according to one embodiment.

FIG. 5 illustrates a timeline of communication and actions between a requesting peer device that supports enhanced link training and a responding peer device that does not support enhanced link training, according to one embodiment.

FIG. 6 illustrates a timeline of communication and actions between a requesting peer device that does not support enhanced link training and a responding peer device that supports enhanced link training, according to one embodiment.

FIG. 7A illustrates an example communication system with devices that include capability detection logic, in accordance with at least some embodiments.

FIG. 7B illustrates a block diagram of an example communication system that includes capability detection logic, according to at least one embodiment.

FIG. 8 illustrates an example computer system including a spectrum hardware engine and an error correction block according to at least one embodiment.

FIG. 9 is a block diagram of a computing system having two processing devices coupled to each other and multiple networks according to at least one embodiment.

FIG. 10 is a block diagram of a computing system having a central processing unit (CPU) and a graphics processing unit (GPU) in a single integrated circuit according to at least one embodiment.

FIG. 11 is a block diagram of a computing system having tensor core graphics processing units (GPUs) according to at least one embodiment.

### DETAILED DESCRIPTION

Before using an enhanced or proprietary capability, a peer device has to verify that the peer device on the other side of the link supports the same capability. Conventionally, detecting whether the other peer device supports the same capability may be performed via auto-negotiation (AN) as defined in IEEE 702.3, clause 73. However, many systems do not support AN. Another way to detect whether the other peer device supports the same capability is to leverage reserved bits within a request, such as reserved bits of the standard link training frame header (see IEEE 702.3, sections 136.8.11.2-3). However, using these reserved bits can be risky, as other companies or types of devices may utilize these reserved bits for other reasons. As such, relying on these reserved bits can lead to the link having undefined conditions.

Aspects and embodiments of the present disclosure address the above-mentioned problems and others by leveraging polarity inversion detection to identify whether a signaling peer device shares the same compatibility with a responding peer device on the other side of a link (e.g., Ethernet). In an embodiment, the signaling peer device may first send a request to the responding peer device. This request may be related to a protocol or process to be performed that involves both the signaling and responding peer devices. The request may also be related to the capability. The request may trigger a response from the responding peer device. However, before sending the response, if the responding peer device supports the compatibility, the responding peer device may invert and revert the polarity of the link. If the signaling peer device supports the capability, the signaling peer device may expect this inversion and reversion of the polarity of the link. Upon the signaling peer device detecting the polarity inversion and reversion, the signaling peer device may determine that the responding peer device supports the same capability, and that an enhanced version of the protocol or process may be performed that utilizes the shared capability. If the signaling peer device does not detect a link polarity inversion/reversion before receiving the response, the signaling peer device may determine that the responding peer device does not support the same capability, and that a standard version of the protocol or process is to be performed.

In some cases, the signaling peer device sends the request to the responding peer device irrespective of whether the signaling peer device supports the capability. In these cases (i.e., where the signaling peer device does not support the capability and the second peer device supports the capability), the signaling peer device may lose frame lock while the responding peer device inverts and reverts the polarity of the link. However, such frame lock loss is typically handled by standard compliant devices, and because the signaling peer device does not support the capability, the signaling peer device will regain frame lock and continue standard operation of the protocol or process ignorant of the compatibility detection scheme described herein.

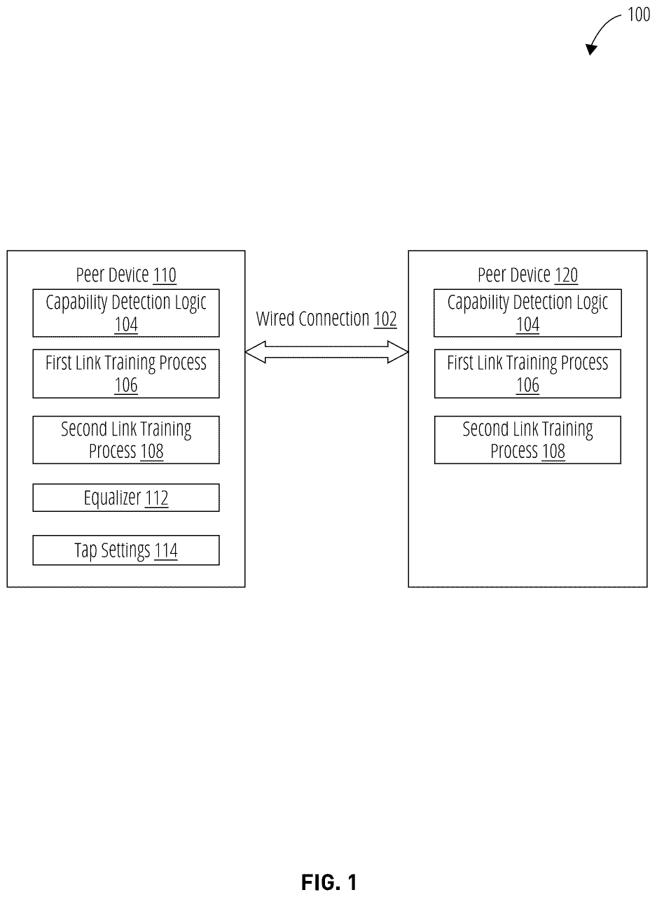

FIG. 1 illustrates a network 100 with a peer device 110 and a peer device 120 with capability detection logic 104, according to one embodiment. The peer device 110 and peer device 120 may be coupled together via a wired connection 102. In some embodiments, this wired connection 102 may be an Ethernet® connection. The wired connection 102 may transmit data using twisted pairs of wires that carry differential signals. Rather than measuring one wire's voltage against a common ground, the receiving peer device may compare the voltage difference between the two wires in a pair. A logical “1” or “0” can determined by whether one wire is more positive or more negative relative to the other. In some cases, a transmitting peer device may invert the voltages of the differential pair of wires, effectively swapping the polarity of the signals. After detecting the inversion, the receiving peer device correctly interpret the signal.

In some embodiments, the peer device 110 and peer device 120 may communicate via serializer/deserializer (SerDes) techniques and technologies. In at least some embodiments, the peer device 110 and peer device 120 may each include a SerDes interface. Generally, SerDes transforms wide parallel data within a transmitting device into a serial stream for transmission, which is then reassembled into parallel form at the receiving device. When data is sent from the peer device 110 to the peer device 120 (or vice versa), the data first passes through a serializer, which sequentially converts parallel data bits into a serial bitstream. At higher throughput rates, such as multi-gigabit rates, the signal traveling across the channel can encounter frequency-dependent attenuation, reflections, and other distortions that make accurate data recovery more difficult at the receiver. Additionally, a physical channel may be subject to impedance mismatches or other types of channel losses which can also impair the ability of the peer device 120 to correctly recover the transmitted data. To mitigate these impairments, the peer device 110 may employ an equalizer 112, often implemented as a multi-tap filter that shapes the transmitted signal to compensate for anticipated channel losses. The filter taps—commonly referred to as pre-cursor, main tap, and post-cursor taps—are assigned numerical coefficients called tap values or tap settings 114. These tap settings 114 are used by the equalizer 112 to determine how much the transmitted signal is boosted or attenuated at various time offsets relative to the main bit, helping to counteract the intersymbol interference (ISI) caused by the physical channel.

Once the peer device 110 has applied the prescribed tap settings 114, the shaped signal is driven onto the differential pair lines toward the peer device 120. Inside the peer device 120, an analog front end (AFE) can further refine and restore the incoming signal. This AFE can also include one or more of Continuous-Time Linear Equalizers (CTLEs), Variable Gain Amplifiers (VGAs), and sometimes decision feedback equalizers (DFEs), all of which help to correct remaining signal distortions. Because the transmitted bitstream may also embed timing information, clock data recovery (CDR) circuitry extracts a timing reference from the incoming waveforms and aligns the bit decisions accordingly. Then, a deserializer at the peer device 120 may convert the high-speed serial data back into a parallel format for local use.

In some embodiments, the peer device 110 and peer device 120 may include a first link training protocol or process 106 that refines and optimizes the tap settings 114 of the equalizer 112. During the first link training process 106, the peer device 110 (acting as the transmitter) and the peer device 120 (acting as the receiver) engage in an iterative process to establish a reliable high-speed data link. First, the peer device 110 sends a known training pattern that the peer device 120 uses to evaluate the signal quality and determine the degree of channel loss, noise, and distortion present. Based on these observations, the peer device 120 adjusts its own internal gain and filter parameters, and then communicates feedback back to the peer device 110. This feedback usually includes guidance on how to modify the tap settings 114 to mitigate the adverse effects of the transmission channel. As the training sequence progresses, the peer device 110 may continue to apply changes to its tap settings 114 in response to feedback from the peer device 120, and the peer device 120 then measures the new signal quality to verify improvement. This “tuning” loop can continue until the receiver confirms that the block error rate and other performance metrics are acceptable. For example, the first link training process 106 may loop until the block error rate is below a first target block error rate (BLER). In some cases, this first target BLER may be somewhere between a range of 1E−6 and 1E−9. The equalizer 112 in the peer device 110 is thus “optimized” by systematically refining the tap settings 114 to best counteract the losses and reflections encountered in the link.

The peer device 110 and peer device 120 may also include a second link training protocol or process 108 that further refines and optimizes the tap settings 114 of the equalizer 112. This second link training process 108 may work similarly to the first link training process 106, but may allow for a more enhanced training of the tap settings 114. According to embodiments, the second link training process 108 may be considered an enhanced version of the first link training process 106. In at least one embodiment, the second link training protocol may have a second target BLER below the first target error rate. In other words, in at least some embodiments, the second link training process enhances (i.e., lowers) the BLER. In some cases, this second target BLER may be at or below 1E−9. During the second link training process 108, the peer device 120 may observe the quality of the incoming signal (e.g., tracking error rates or eye openings) and determine whether adjusting the tap settings of the equalizer 112 will improve performance. In some embodiments, the peer device 120 may generate optimized tap settings for the equalizer 112 in the form of a look-up table (LUT). These optimized tap settings may be referred to as tap configuration data. Tap configuration data may communicate tap adjustments in various ways. For example, the tap configuration data may provide increase or decrease commands that allows the peer device 110 to make small adjustments and iterate toward an optimal solution. In another example, the tap configuration data may include tap values that the peer device 120 has determined to be optimal tap settings (e.g., absolute best coefficients) that replace the existing tap settings of the peer device 110. In another example, the tap configuration data includes delta values that indicate how much each tap should increase or decrease. Another example may include a feedback or error-signal mechanism, where tap configuration data includes an error gradient that the peer device 110 relies on to adjust its tap settings based on that feedback. Another example may include sending a non-linear LUT. After generating the tap configuration data, the peer device 120 may send the tap configuration data to the peer device 110. Similar to the first link training process 106, this iterative loop between the peer device 110 and peer device 120 of the second link training process 108 may be repeated until the second target BLER is achieved.

In some embodiments, the first link training process 106 may be standard across many different types of peer devices. However, the second link training process 108 may only be performed by certain types of peer devices. As such, a peer device that has the capability of performing the second link training process 108 may use capability detection logic 104 to determine whether a peer device across a link also has the capability of performing the second link training process 108. While the description herein describes the capability detection logic 104 as capable of determining whether a coupled peer device includes the second link training process 108, the capability detection logic 104 may be incorporated into any device to determine whether a peer device across a wired connection shares any same capability. For example, the capability detection logic 104 may be used to determine whether a peer device supports an enhanced encryption process, an enhanced compression or decompression algorithm, a non-standard quality of service (QoS) prioritization protocol, or the like.

In some embodiments, if both the peer device 110 and peer device 120 support the capability (here, the second link training process 108), each of the peer device 110 and peer device 120 may comprise the capability detection logic 104. The capability detection logic 104 may perform different actions depending on whether the respective peer device is requesting a response related to the capability (sometimes referred to as the requesting peer device) or the respective peer device is responding to the request (sometimes referred to as the responding peer device). For exemplary purposes, assume that the peer device 110 is the requesting device and the peer device 120 is the responding device.

After the peer device 110 sends the request to the peer device 120, the peer device 120 may invert the polarity of the wired connection 102. Then, the peer device 120 may revert the polarity of the wired connection 102. The peer device 110 may detect the inversion and reversion of the polarity of the wired connection 102. After the inversion and reversion of the polarity of the wired connection 102, the peer device 120 may then respond to the request. Because the peer device 110 detected the inversion and reversion of the polarity of the wired connection 102 before receiving the response from the peer device 120, the peer device 110 can conclude that the peer device 120 shares the capability.

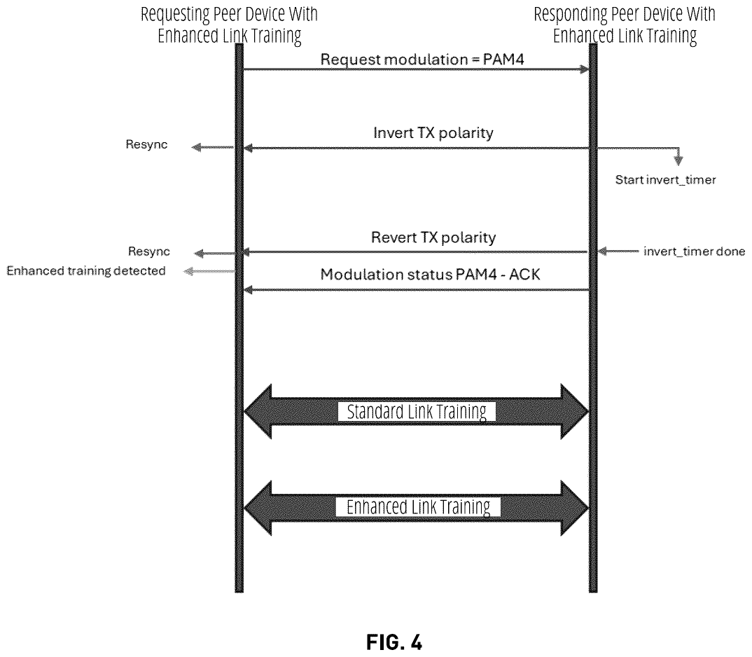

In at least one embodiment, a timeline of communication and actions of the capability detection logic 104 between a requesting peer device and a responding peer device that each support an enhanced link training capability is illustrated in FIG. 4. First, the requesting peer device requests initiation of a PAM4 link training process. Then, the responding peer device sequentially inverts and reverts the polarity of the shared wired connection. Afterwards, the responding peer device sends an acknowledgement (ACK) message to the requesting peer device corresponding to the PAM link training request. Because the requesting peer device detected the polarity inversion and reversion before receiving the ACK message response, the requesting peer device may conclude that the responding peer device supports enhanced link training. As such, the requesting and responding peer devices may participate in the enhanced link training. In at least one embodiment, the enhanced link training (e.g., second link training process 108) may be performed after standard link training (e.g., first link training process 106).

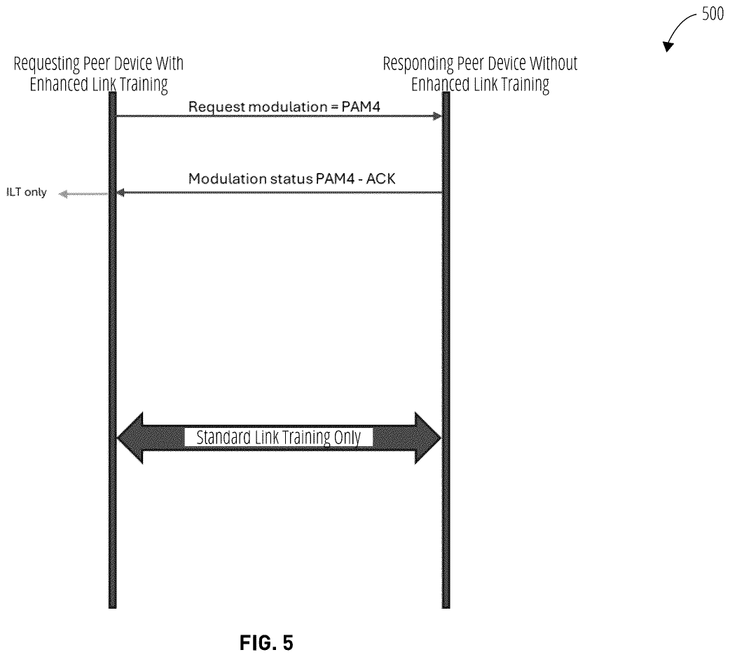

However, if the peer device 120 does not share the capability, the peer device 120 will respond to the request from the peer device 110 before inverting and reverting the polarity of the wired connection 102. Here, because the peer device 110 receives the response to the request before detection an inversion and reversion of the polarity of the wired connection 102, the peer device 110 can conclude that the peer device 120 does not support the capability. This is illustrated by FIG. 5.

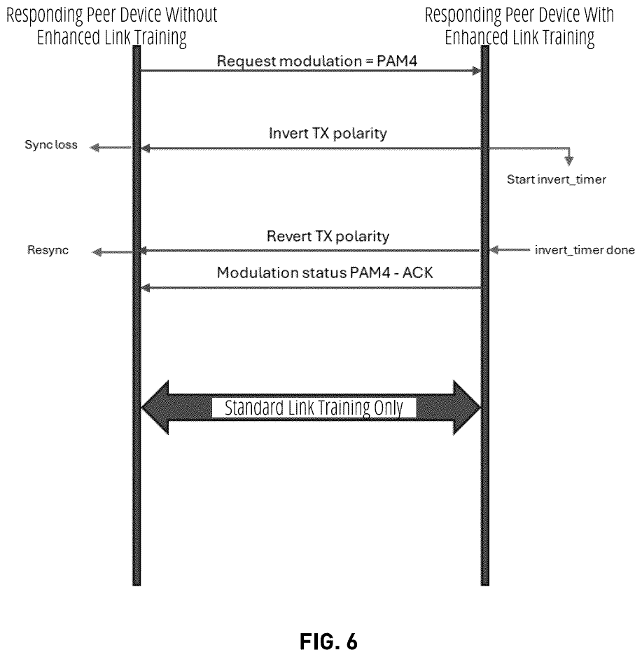

In embodiments where the peer device 120 supports the capability but the peer device 110 does not support the capability, the peer device 120 may still invert and revert the polarity of the wired connection 102 upon receiving the request from the peer device 110. This may cause the peer device 110 to lose synchronization with the peer device 120. However, auto polarity detection may allow the peer device 110 to quickly resynchronize (i.e., regain synchronization). After inverting and reverting the polarity of the wired connection 102, the peer device 120 may then respond to the request. This is illustrated by FIG. 6.

In some embodiments, the peer device 120 may respond to the request within a threshold amount of time. This threshold amount of time may correspond to an amount of time required for the peer device 110 to receive the response before the peer device 110 determines that there has been a failure in communication. In at least some embodiments, this threshold amount of time may be around 20 ms. This threshold amount of time may be dependent on the design, requirements, and/or specifications of the peer device 110 and peer device 120.

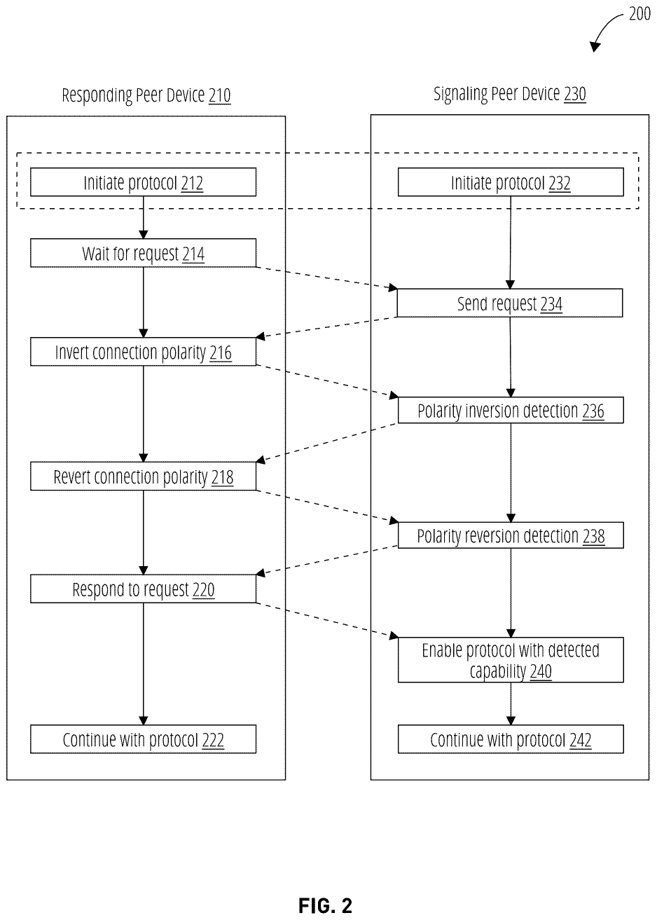

FIG. 2 is a flowchart illustrating a method 200 of detecting a capability within a peer device, according to one embodiment. The method 200 may be performed by the capability detection logic 104, as described herein. The capability detection logic 104 may include processing logic that may comprise hardware (e.g., circuitry, dedicated logic, programmable logic, microcode, etc.), software (e.g., instructions run on a processing device to perform hardware simulation), firmware, or a combination thereof. In some embodiments, the method 200 may be performed by a serializer/deserializer (SerDes) interface. The method 200 may be performed at least partially by other devices, such as one or more processors external to the SerDes interface. Instructions may be stored within memory that are executed by one or more processors internal and/or external to the SerDes interface to perform the method 200. The method 200 may be performed by any devices that interface using at least one differential pair of wires.

Illustrated are a responding peer device 210 and a signaling peer device 230. Each of these peer devices 210, 230 may include some or all of the features described above with respect to the peer device 110 and peer device 120 of FIG. 1.

First, the responding peer device 210 and signaling peer device 230 may initiate a protocol or process. The protocol may be initiated by the signaling peer device 230 (i.e., block 232), the responding peer device 210 (i.e., block 212), or both. There are many ways two peer devices can initiate a new protocol or process once they have established basic communication. In at least one embodiment, there may be no basic communication before the method 200 is completed. Instead, the method 200 may be initiated when the peer devices detect each other. The peer device may detect each other by receiving energy or detecting a low impedance. In embodiments where basic communication is conveyed before the method 200, one common approach at the application layer may be the request/response model, such as hypertext transfer protocol (HTTP) or representational state transfer (REST) application programming interfaces (APIs), where one device sends a request to the other device, which responds with data or confirmation, thereby launching the intended action. Another related method on initiating a protocol or process involves remote procedure calls (RPC), in which one device “calls a function” on the other across the network-using protocols like Google® remote procedure call (gRPC) or simple object access protocol (SOAP)-to trigger a process on the remote machine and receive results as though they were local. Alternatively, a publish/subscribe mechanism (as seen in message queuing telemetry transport (MQTT) or advanced message queuing protocol (AMQP)) allows a device to subscribe to specific topics or queues; when the other device publishes a message on that topic, it immediately initiates a process or workflow on the subscriber's end. Beyond these request-based methods, event-driven protocols or hooks can also kick off new processes between two peers.

Once the protocol or process has been initiated, the signaling peer device 230 may send a related request at block 234. The signaling peer device 230 may expect a response to the request from the responding peer device 210.

If the responding peer device 210 knows that the protocol has been initiated, the responding peer device 210 may wait for the request from the signaling peer device 230 at block 214. Once the request is received, instead of promptly sending the response, the responding peer device 210 may first invert the connection polarity at block 216 and revert the polarity at block 218. In at least one embodiment, the responding peer device 210 may wait a predetermined amount of time after inverting the connection polarity at block 216 before reverting the connection polarity at block 218. After the responding peer device 210 has inverted the connection polarity at block 216 but before the responding peer device 210 reverts the connection polarity, the signaling peer device 230 may detect the polarity inversion at block 236. Then, after the responding peer device 210 reverts the connection polarity, the signaling peer device 230 may detect the polarity reversion at block 238.

After the responding peer device 210 reverts the connection polarity at block 218, the responding peer device 210 may then send the response to the request to the signaling peer device 230. Because the signaling peer device 230 detected the inversion and reversion of the connection polarity before receiving the response, the signaling peer device 230 may conclude that the responding peer device 210 supports the capability, and may continue with the protocol or process with the supported capability at block 242.

In at least some embodiments, the responding peer device 210 may continue with the protocol or process at block 222 without knowing whether the signaling peer device 230 supports the capability. However, the capability may be utilized by both the responding peer device 210 and signaling peer device 230 without the responding peer device 210 requiring this knowledge. However, in at least some embodiments, the responding peer device 210 may need to know that the signaling peer device 230 also supports the capability. In at least some of these embodiments, the signaling peer device 230 may invert and revert the connection polarity before continuing with the process or protocol at block 242. In one embodiment, while the method 200 is described as a unidirectional protocol, the roles of the signaling peer device 230 and responding peer device 210 may be performed by both peer devices in parallel (i.e., the protocol may be bidirectional). This way, the responding peer device 210 may receive confirmation that the signaling peer device 230 also supports the capability. In other embodiments, the responding peer device 210 may confirm that the signaling peer device 230 supports the capability another way.

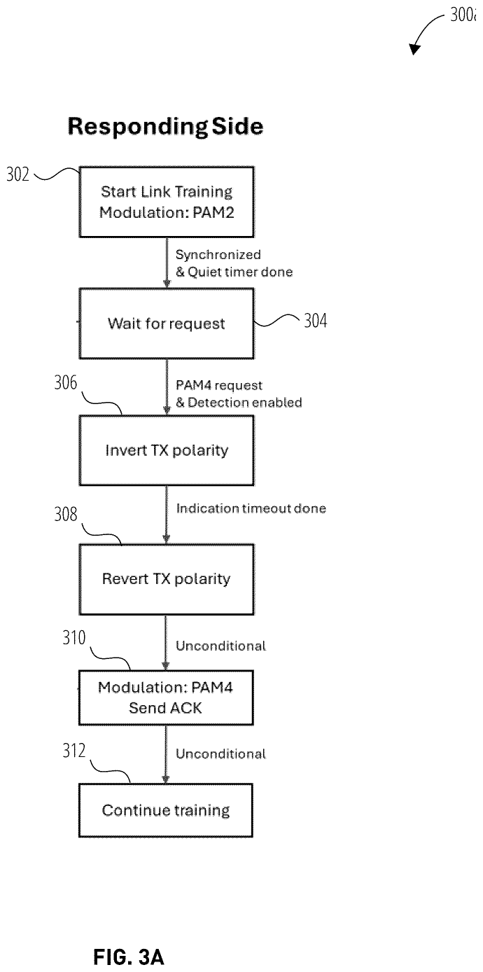

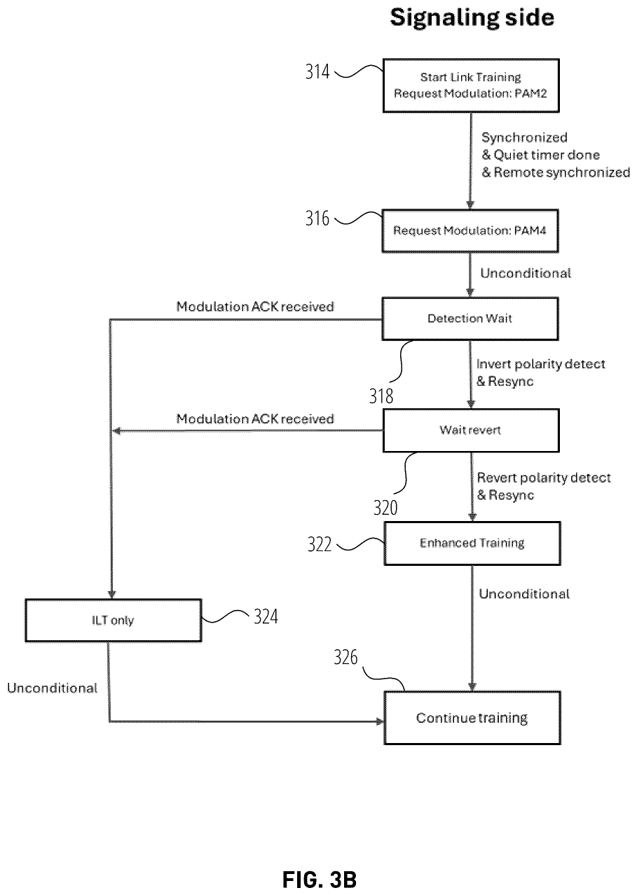

FIG. 3A is a flowchart illustrating a method 300a of a capability detection process performed by a responding peer device coupled to a signaling peer device by an Ethernet® connection. FIG. 3B is a flowchart illustrating a method 300b of the capability detection process performed by the signaling peer device. The methods 300a, 300b may be performed by the capability detection logic 104, as described herein. The capability detection logic 104 may include processing logic that may comprise hardware (e.g., circuitry, dedicated logic, programmable logic, microcode, etc.), software (e.g., instructions run on a processing device to perform hardware simulation), firmware, or a combination thereof. In some embodiments, the methods 300a, 300b may be performed by a serializer/deserializer (SerDes) interface. The methods 300a, 300b may be performed at least partially by other devices, such as one or more processors external to the SerDes interface. Instructions may be stored within memory that are executed by one or more processors internal and/or external to the SerDes interface to perform the methods 300a, 300b. The methods 300a, 300b may be performed by any devices that interface using at least one differential pair of wires.

At block 302, the responding peer device starts link training with the signaling peer device (also referred to as the requesting peer device) at pulse amplitude modulation level-2 (PAM2). After the responding and signaling peer devices are synchronized at PAM2 and a quiet time has expired, the responding peer device may wait for a request at block 304. Here, the responding peer device may be waiting for a request to start link training modulation at PAM4.

After the responding peer device receives the PAM4 request, the responding peer device may invert the polarity of the connection between the responding and signaling peer devices at block 306. Then, after expiration of an optional timer, the responding peer device may revert the polarity of this connection at block 308.

At block 310, after inverting and reverting the connection between the responding and signaling peer devices, the responding peer device may respond to the request and send a PAM4 acknowledgement message (ACK message) to the signaling device. The responding peer device may then continue with the link training process at block 312.

At block 314, the signaling peer device starts link training with the responding peer device at PAM2. After the responding and signaling peer devices are synchronized at PAM2 and a quiet time has expired, the signaling peer device may send a request to the responding peer device to start link training at PAM4 at block 316.

At block 318, the signaling peer device may wait to detect a polarity inversion of the connection between the signaling and responding peer device. If a polarity inversion of this connection is detected, the signaling peer device may then wait to detect a polarity reversion of the connection at block 320. If a polarity reversion of this connection is detected, the signaling peer device may conclude that the responding peer device supports an enhanced peer link training capability, and may enable this enhanced training at block 322. However, if the signaling peer devices receives an ACK message from the responding peer device before detecting both the polarity inversion and reversion of the connection, the signaling peer device may conclude that the responding peer device does not support the enhanced training, and may only enable standard link training at block 324. The signaling peer device may then continue with the link training process at block 326.

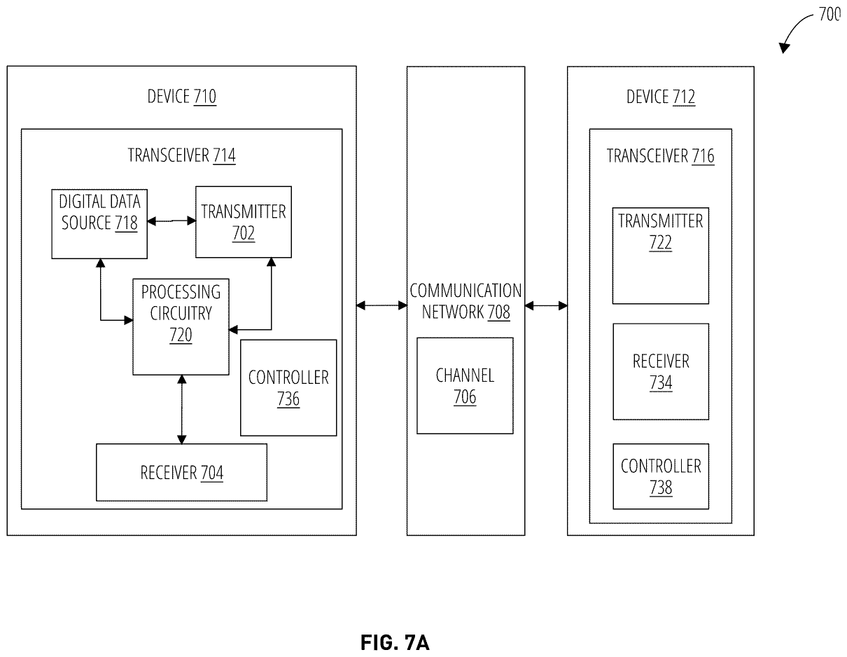

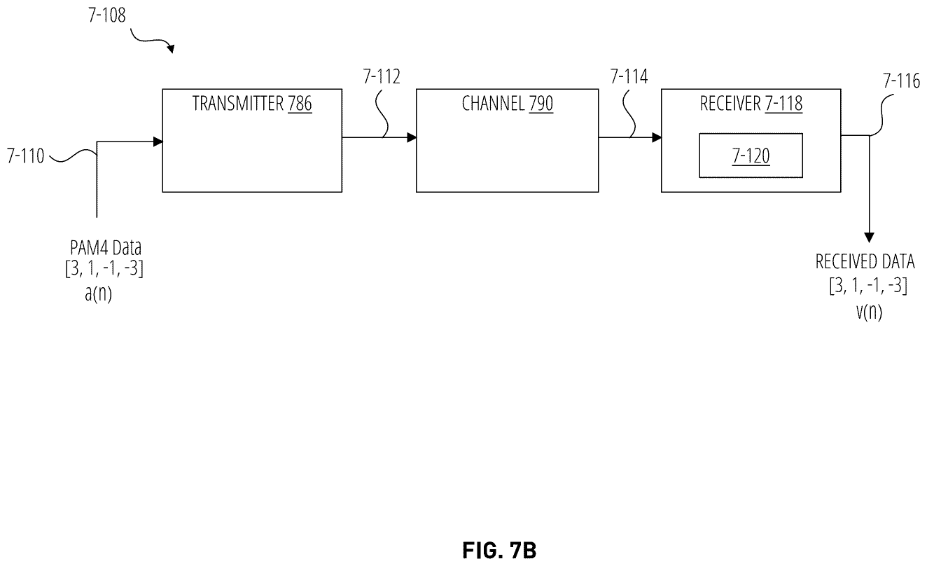

FIG. 7A illustrates an example communication system 700 with a controller 736, in accordance with at least some embodiments. The communication system 700 includes a device 710, a communication network 708 including a communication channel 706, and a device 712. In at least one embodiment, the devices 710 and 712 are integrated circuits of a Personal Computer (PC), a laptop, a tablet, a smartphone, a server, a collection of servers, or the like. In some embodiments, the devices 710 and 712 may correspond to any appropriate type of device that communicates with other devices also connected to a common type of communication network 708. In embodiments where the communication network 708 includes at least one differential pair of wires, the devices 710, 712 may each include the capability detection logic 104 and may each be capable of detecting whether the other supports one or more same capabilities by inverting and reverting the polarity of the differential pair of wires (or detecting the inversion and reversion). According to embodiments, the transmitter 702 and 722 of devices 710 or 712 may correspond to transmitters of a Graphics Processing Unit (GPU), a switch (e.g., a high-speed network switch), a network adapter, a central processing unit (CPU), a data processing unit (DPU), etc.

Examples of the communication network 708 that may be used to connect the devices 710 and 712 include wires, conductive traces, bumps, terminals, optical fibers, or the like. In other embodiments, the communication network 708 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 708 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 708 is a network that enables data transmission between the devices 710 and 712 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, a network interface comprising a receiver or transceiver with the controller In at least one embodiment, a system for high-speed network communication includes a processing unit, a network interface comprising a receiver or transceiver with controller or other processing device to optimize link training processes, as described herein. The processing unit can include a CPU, a GPU, a DPU, a network adapter, a network switch, an NVLink switch, or the like. Other examples for the communication network 708 can include other chip-to-chip or die-to-die interconnects, such as GRS, LPI (low power interface) or LLI (low latency interface).

The device 710 includes a transceiver 714 for sending and receiving signals, for example, data signals. The data signals may be digital or optical signals modulated with data or other suitable signals for carrying data.

The transceiver 714 may include a digital data source 718, a transmitter 2402, a receiver 704, and processing circuitry 720 that controls the transceiver 714. The digital data source 718 may include suitable hardware and/or software for outputting data in a digital format (e.g., in binary code and/or thermometer code). The digital data output by the digital data source 718 may be retrieved from memory (not illustrated) or generated according to input (e.g., user input).

The transceiver 714 includes suitable software and/or hardware for receiving digital data from the digital data source 718 and outputting data signals according to the digital data for transmission over the communication network 708 to a transceiver 716 of device 712.

The receiver 704 of device 710 may include suitable hardware and/or software for receiving signals, for example, data signals from the communication network 708. For example, the receiver 704 may include components for receiving processing signals to extract the data for storing in a memory. In at least one embodiment, the transceiver 716 includes a transmitter 722 and receive 734. The transceiver 716 receives an incoming signal and samples the incoming signal to generate samples, such as using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO) that controls the sampling of the subsequent data by the ADC.

The processing circuitry 720 may comprise software, hardware, or a combination thereof. For example, the processing circuitry 720 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 720 may comprise hardware, such as an Application-Specific Integrated circuit (ASIC). Other non-limiting examples of the processing circuitry 720 include an Integrated Circuit (IC) chip, a CPU, A GPU, a DPU, a microprocessor, a Field-Programmable Gate Array (FPGA), a collection of logic gates or transistors, resistors, capacitors, inductors, diodes, or the like. Some or all of the processing circuitry 720 may be provided on a Printed Circuit Board (PCB) or collection of PCBs. It should be appreciated that any appropriate type of electrical component or collection of electrical components may be suitable for inclusion in the processing circuitry 720. The processing circuitry 720 may send and/or receive signals to and/or from other elements of the transceiver 714 to control the overall operation of the transceiver 714.

The transceiver 714 or selected elements of the transceiver 714 may take the form of a pluggable card or controller for the device 710. For example, the transceiver 714 or selected elements of the transceiver 714 may be implemented on a network interface card (NIC).

The device 712 may include a transceiver 716 for sending and receiving signals, for example, data signals over a channel 706 of the communication network 708. The channel 2406 can be PCIe, NVLink, Ethernet, InfiniBand, Ground Reference Signal (GRS), Chip-to-Chip (C2C), Die-to-Die (D2D), or the like. The same or similar structure of the transceiver 714 may be applied to transceiver 716, and thus, the structure of transceiver 716 is not described separately.

Although not explicitly shown, it should be appreciated that devices 710 and 712 and the transceiver 714 and transceiver 716 may include other processing devices, storage devices, and/or communication interfaces generally associated with computing tasks, such as sending and receiving data.

FIG. 7B illustrates a block diagram of an example communication system 7-108 employing a receiver 7-118 with a controller 7-120, according to at least one embodiment. In the example shown in FIG. 7B, a Pulse Amplitude Modulation level-4 (PAM4) modulation scheme is employed with respect to the transmission of a signal (e.g., digitally encoded data) from a transmitter (TX) 786 to a receiver (RX) 7-118 via a communication channel 790 (e.g., a transmission medium). In at least one embodiment, the receiver 7-118 and transmitter 786 may each include the capability detection logic 104 and be capable of detecting one or more shared capabilities as described and illustrated in FIGS. 1-6. The communication channel 790 can be PCIe, NVLink, Ethernet, InfiniBand, GRS, C2C, D2D, or the like. In this example, the transmitter 786 receives an input data 7-110 (i.e., the input data at time n is represented as “a(n)”), which is modulated in accordance with a modulation scheme (e.g., PAM4) and sends the signal 7-112 a(n) including a set of data symbols (e.g., symbols −3, −1, 1, 3, where the symbols represent coded binary data). It is noted that while the use of the PAM4 modulation scheme is described herein by way of example, other data modulation schemes can be used in accordance with embodiments of the present disclosure, including for example, a non-return-to-zero (NRZ) modulation scheme, PAM3, PAM7, PAM8, PAM16, etc. For example, for an NRZ-based system, the transmitted data symbols consist of symbols −1 and 1, with each symbol value representing a binary bit. This is also known as a PAM level-2 or PAM2 system as there are 2 unique values of transmitted symbols. Typically, a binary bit 0 is encoded as −1, and a bit 1 is encoded as 1 as the PAM2 values.

In the example shown, the PAM4 modulation scheme uses four (4) unique values of transmitted symbols to achieve higher efficiency and performance. The four levels are denoted by symbol values −3, −1, 1, 3, with each symbol representing a corresponding unique combination of binary bits (e.g., 00, 01, 10, 11).

The communication channel 790 is a destructive medium in that the channel acts as a low pass filter which attenuates higher frequencies more than it attenuates lower frequencies, introduces inter-symbol interference (ISI) and noise from cross talk, from power supplies, from Electromagnetic Interference (EMI), or from other sources. The communication channel 790 can be over serial links (e.g., a cable, PCB traces, copper cables, optical fibers, or the like), read channels for data storage (e.g., hard disk, flash solid-state drives (SSDs), high-speed serial links, deep space satellite communication channels, applications, or the like. The receiver (RX) 7-118 receives an incoming signal 7-114 over the channel 790. The receiver 7-118 can output a received signal 7-116, “v(n),” including the set of data symbols (e.g., symbols −3, −1, 1, 3, wherein the symbols represent coded binary data).

In at least one embodiment, the transmitter 786 can be part of a SerDes IC. The SerDes IC can be a transceiver that converts parallel data to serial data and vice versa. The SerDes IC can facilitate transmission between two devices over serial streams, reducing the number of data paths, wires/traces, terminals, etc. The receiver 7-118 can be part of a SerDes IC. The SerDes IC can include a clock-recovery circuit. The clock-recovery circuit can be coupled to an ADC and an equalization block. In another embodiment, the SerDes IC can include additional equalization block before a symbol detector. In at least some embodiments, the SerDes IC may include some or all of the features of the capability detection logic 104 as described herein.

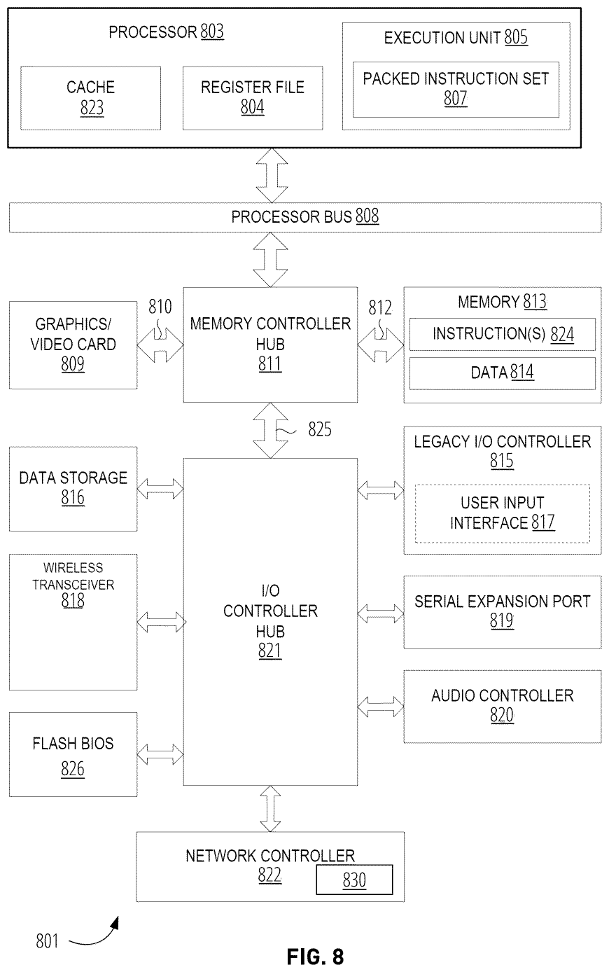

FIG. 8 illustrates an example computer system 801, including an error correction circuit 830, in accordance with at least some embodiments. In at least one embodiment, computer system 801 may be a system with interconnected devices and components, an SOC, or some combination. In at least one embodiment, computer system 801 is formed with a processor 803 that may include execution units to execute an instruction. In at least one embodiment, computer system 801 may include, without limitation, a component, such as a processor 803, to employ execution units including logic to perform algorithms for processing data. In at least one embodiment, computer system 801 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 801 may execute a version of WINDOWS' operating system available from Microsoft Corporation of Redmond, Wash., although other operating systems (UNIX and Linux, for example), embedded software, and/or graphical user interfaces, may also be used.

In at least one embodiment, computer system 801 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 801 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 801 may include, without limitation, processor 803 that may include, without limitation, one or more execution units 805 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 801 is a single processor desktop or server system. In at least one embodiment, computer system 801 may be a multiprocessor system. In at least one embodiment, processor 803 may include, without limitation, a CISC microprocessor, a RISC microprocessor, a VLIW microprocessor, and a processor implementing a combination of instruction sets, or any other processor device, such as a digital signal processor, for example. In at least one embodiment, processor 803 may be coupled to a processor bus 808 that may transmit data signals between processor 803 and other components in computer system 801.

In at least one embodiment, processor 803 may include, without limitation, a Level 1 (“L1”) internal cache memory (“cache”) 823. In at least one embodiment, processor 803 may have a single internal cache or multiple levels of internal cache. In at least one embodiment, cache memory may reside external to processor 803. In at least one embodiment, processor 803 may also include a combination of both internal and external caches. In at least one embodiment, a register file 804 may store different types of data in various registers including, without limitation, integer registers, floating point registers, status registers, and instruction pointer register.

In at least one embodiment, execution unit 805, including, without limitation, logic to perform integer and floating point operations, also resides in processor 803. Processor 803 may also include a microcode (“ucode”) read only memory (“ROM”) that stores microcode for certain macro instructions. In at least one embodiment, execution unit 805 may include logic to handle a packed instruction set 807. In at least one embodiment, by including packed instruction set 807 in an instruction set of a general-purpose processor 803, along with associated circuitry to execute instructions, operations used by many multimedia applications may be performed using packed data in a general-purpose processor 803. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 806 may also be used in microcontrollers, embedded processors, graphics devices, DSPs, and other types of logic circuits. In at least one embodiment, computer system 801 may include, without limitation, a memory 813. In at least one embodiment, memory 813 may be implemented as a DRAM device, an SRAM device, flash memory device, or other memory devices. Memory 813 may store instruction(s) 824 and/or data 814 represented by data signals that may be executed by processor 803.

In at least one embodiment, a system logic chip may be coupled to a processor bus 808 and memory 813. In at least one embodiment, the system logic chip may include, without limitation, a memory controller hub (“MCH”) 811, and processor 803 may communicate with MCH 811 via processor bus 808. In at least one embodiment, MCH 811 may provide a high bandwidth memory path 812 to memory 813 for instruction and data storage and for storage of graphics commands, data, and textures. In at least one embodiment, MCH 811 may direct data signals between processor 803, memory 813, and other components in computer system 801 and may bridge data signals between processor bus 808, memory 813, and a system I/O 825. In at least one embodiment, a system logic chip may provide a graphics port for coupling to a graphics controller. In at least one embodiment, MCH 811 may be coupled to memory 813 through high bandwidth memory path 812, and graphics/video card 809 may be coupled to MCH 811 through an Accelerated Graphics Port (“AGP”) interconnect 810.

In at least one embodiment, computer system 801 may use system I/O 825 that is a proprietary hub interface bus to couple MCH 811 to I/O controller hub (“ICH”) 821. In at least one embodiment, ICH 821 may provide direct connections to some I/O devices via a local I/O bus. In at least one embodiment, a local I/O bus may include, without limitation, a high-speed I/O bus for connecting peripherals to memory 813, a chipset, and processor 803. Examples may include, without limitation, an audio controller 820, a firmware hub (“flash BIOS”) 726, a wireless transceiver 818, a data storage 816, a legacy I/O controller 815 containing a user input interface 817, a keyboard interface, a serial expansion port 819, such as a USB, and a network controller 822. In at least one embodiment, the network controller 822 includes the error correction circuit 830. Data storage 816 may comprise a hard disk drive, a floppy disk drive, a CD-ROM device, a flash memory device, or other mass storage device.

In at least one embodiment, FIG. 8 illustrates a system, which includes interconnected hardware devices or “chips.” In at least one embodiment, FIG. 8 may illustrate an example SoC. In at least one embodiment, devices illustrated in FIG. 8 may be interconnected with proprietary interconnects, standardized interconnects (e.g., PCIe), or some combination thereof. In at least one embodiment, one or more components of system 802 are interconnected using compute express link (“CXL”) interconnects.

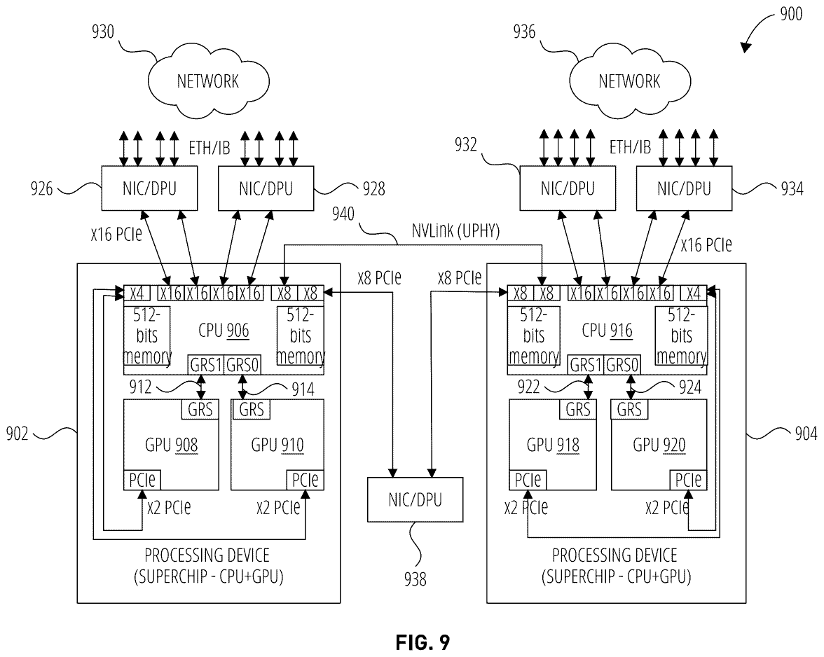

FIG. 9 is a block diagram of a computing system 900 having two processing devices coupled to each other and multiple networks according to at least one embodiment. The computing system 900 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 900. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 900 highly suitable for demanding applications that require significant processing power, such as artificial intelligence (AI), machine learning (ML), and data-intensive computing, while ensuring robust connectivity and scalability across various networked environments. The integrated circuits of the computing system 900 can include one or more CPUs and one or more GPUs. An example architecture of a multi-GPU architecture is illustrated in FIG. 9.

As illustrated in FIG. 9, the computing system 900 includes a processing device 902 with a multi-GPU architecture. In particular, the processing device 902 includes a CPU 906, a GPU 908, and a GPU 910. The CPU 906 can be coupled to the GPU 908 via an die-to-die (D2D) or chip-to-chip (C2C) interconnect 912, such as a Ground-Referenced Signaling interconnect (GRS interconnect). The CPU 906 can be coupled to the GPU 910 via a D2D or C2C interconnect 914. The CPU 906 can also couple to the GPU 908 and GPU 910 via PCIe interconnects. The CPU 906 can be coupled to one or more network interface cards (NICs) or data processing units (DPUs), which are coupled to one or more networks. For example, as illustrated in FIG. 9, the CPU 906 is coupled to a first NIC/DPU 926, which is coupled to a network 930. The CPU 906 is also coupled to a second NIC/DPU 928, which is coupled to the network 930. The NIC/DPU 926 and NIC/DPU 928 can be coupled to the network 930 over Ethernet (ETH) or InfiniBand (IB) connections.

The computing system 900 also includes a processing device 904 with a multi-GPU architecture. In particular, the processing device 904 includes a CPU 916, a GPU 918, and a GPU 920. The CPU 916 can be coupled to the GPU 918 via an D2D or C2C interconnect 922. The CPU 916 can be coupled to the GPU 920 via a D2D or C2C interconnect 924. The CPU 916 can also couple to the GPU 918 and GPU 920 via PCIe interconnects. The CPU 916 can be coupled to one or more NICs or DPUs, which are coupled to one or more networks. For example, as illustrated in FIG. 9, the CPU 916 is coupled to a first NIC/DPU 932, which is coupled to a network 936. The CPU 916 is also coupled to a second NIC/DPU 934, which is coupled to the network 936. The NIC/DPU 932 and NIC/DPU 934 can be coupled to the network 936 over Ethernet (ETH) or InfiniBand (IB) connections.

In at least one embodiment, the processing device 902 and the processing device 904 can communication with each other via a NIC/DPU 938, such as over PCIe interconnects. The processing device 902 and processing device 904 can also communicate with each other over a high-bandwidth communication interconnects 940, such as an NVLink interconnect or other high-speed interconnects. The NIC/DPUs of FIG. 9 can be the various embodiments of the DPUs described herein.

In at least one embodiment, the computing system 900 is used for high-speed network communication and includes a processing unit (e.g., CPU 906, GPU 908, GPU 910, CPU 916, GPU 918, GPU 920, NIC/DPU 926, NIC/DPU 928, NIC/DPU 932, NIC/DPU 934, or NIC/DPU 938), and a network interface coupled to the processing unit. The network interface can include the operations and functionality of the DPUs described herein.

In at least one embodiment, the computing system 900 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

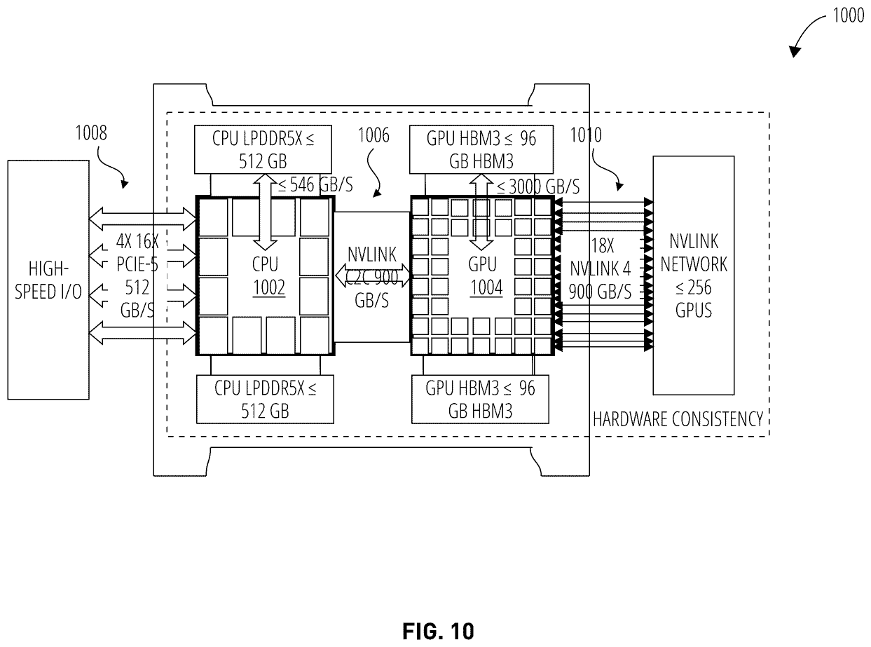

FIG. 10 is a block diagram of a computing system 1000 having a CPU 1002 and a GPU 1004 in a single integrated circuit according to at least one embodiment. The computing system 1000 can be a highly integrated design where a CPU 1002 and GPU 1004 are connected on a single integrated circuit, utilizing an NVLink C2C (Chip-to-Chip) interconnect 1006 to enable fast, low-latency communication between the two processing units. This close integration allows for efficient data transfer and parallel processing between the CPU 1002 and GPU 1004, optimizing performance for complex computational tasks. The GPU elements within the computing system 1000 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 1010. Additionally, the computing system 1000 can be designed to interface with a high-speed I/O through PCIe interconnects 1008, ensuring rapid data transfer to and from external devices, further enhancing the system's capabilities in handling data-intensive tasks and providing robust connectivity to peripheral components. It should be noted that the C2C interconnects 1006 can be considered D2D interconnects since the CPU 1002 and the GPU 1004 are located on the same integrated circuit. The integrated circuit can include CPU memory (also referred to as main memory) and GPU memory, which are accessible by the CPU 1002 and the GPU 1004, respectively, over high-speed interconnects. The computing system 1000 can bring together performance of the GPU 1004 with the versatility of the CPU 1002. The CPU 1002 can be connected with a high-bandwidth and memory coherent C2C interconnects 1006 in a single integrated circuit. The computing system 1000 can support a link switch system.

In at least one embodiment, the computing system 1000 is used for high-speed network communication and includes a processing unit, and a network interface coupled to the processing unit. The network interface can include the operations and functionality of the DPUs described herein.

In at least one embodiment, the computing system 1000 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

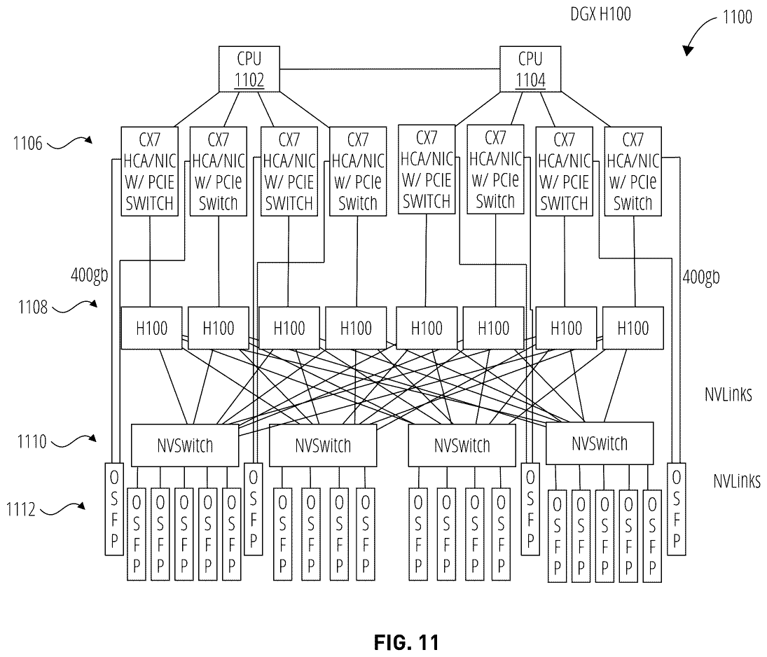

FIG. 11 is a block diagram of a computing system 1100 having tensor core GPUs 1108 according to at least one embodiment. The computing system 1100 can be a DGX H100 system, which is a high-performance computing platform designed to meet the demands of AI, ML, and deep learning (DL) workloads. The computing system 1100 can include multiple tensor core GPUs 1108 (e.g., NVIDIA H100 Tensor Core GPUs). The tensor core GPUs 1108 can be optimized for AI/ML/DL applications, offering exceptional performance for deep learning training, inference, and high-performance computing tasks. The tensor core GPUs 1108 within the computing system 1100 are interconnected using high-speed communication interfaces like NVLinks, enabling rapid data transfer between them, which is crucial for handling large-scale AI models and datasets with low latency. This computing system 1100 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1108, the computing system 1100 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1108 for their specific applications. The computing system 1100 is ideally suited for large-scale AI model training, real-time inference, scientific simulations, data analytics, and other compute-intensive tasks that require massive parallel processing power.

The tensor core GPUs 1108 can be coupled to multiple CPUs, such as CPU 1102 and CPU 1104, using switches 1106 (e.g., CX7 HCA/NIC with PCIe switch). The tensor core GPUs 1108 can be coupled to each other via switches 1110 (e.g., NVSwitches). The switches 1106 and switches 1110 can be coupled to high-speed transceiver modules 1112. The high-speed transceiver modules 1112 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1100 remains capable of meeting increasing data demands and can be upgraded to support future advancements in network speeds, thus contributing to the system's overall performance and scalability.

In at least one embodiment, the computing system 1100 can be considered a data-network configuration with full-bandwidth intra-server NVLinks. In this example, all eight tensor core GPUs 1108 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1108 can half-subscribe eighteen NVLinks to GPUs in other servers. Four tensor core GPUs 1108 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1108 can independently transfer data, using Remote Direct Memory Access (RDMA) protocol, over its own dedicated switch (e.g., 400 Gb/s HCA/NIC) in a multi-rail InfiniBand/Ethernet configuration. In this example, 800 GBps of aggregate full-duplex to non-NVLink network devices.

In at least one embodiment, the computing system 1100 is used for high-speed network communication and includes a processing unit (e.g., CPU 1102, CPU 1104, switches 1106, tensor core GPUs 1108, switches 1110, high-speed transceiver modules 1112), and a network interface coupled to the processing unit. The network interface can include a receiver or a transceiver and perform the corresponding operations and functionalities described herein. The processing unit can include a CPU, a GPU, a DPU, a network adapter, a network switch, an NVLink switch, or the like.

In at least one embodiment, the computing system 1100 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still CO-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
inverting a polarity of a wired connection that couples a first peer device to a second peer device;
reverting the polarity of the wired connection; and
based on the inverting and the reverting of the wired connection, determining that the first peer device and the second peer device share a capability.

2. The method of claim 1, wherein the determining that the first peer device and the second peer device share the capability comprises:
detecting, by the first peer device, a polarity inversion of the wired connection; and
detecting, by the first peer device, a polarity reversion of the wired connection.

3. The method of claim 2, further comprising:
resynchronizing, by the first peer device, to the polarity inversion of the wired connection; and
resynchronizing, by the first peer device, to the polarity reversion of the wired connection.

4. The method of claim 1, wherein the first peer device inverts and reverts the polarity of the wired connection.

5. The method of claim 4, further comprising:
receiving, by the first peer device, a request from the second peer device, wherein the inverting of the polarity of the wired connection is in response to receiving the request; and
sending, by the first peer device to the second peer device, an acknowledgement message corresponding to the request after the reverting of the polarity of the wired connection.

6. The method of claim 5, wherein the acknowledgement message is sent within a threshold amount of time from receiving the request.

7. The method of claim 1, further comprising:
after determining that the first peer device and the second peer device share the capability, performing an operation corresponding to the capability.

8. The method of claim 1, wherein the capability is a link training process that enhances a block error rate (BLER) of data transmitted between the first and second peer devices.

9. A method of operating a first device, the method comprising:
sending a request to a second device over a wired connection;
after sending the request, detecting a polarity inversion of the wired connection; and
based on detecting the polarity inversion, determining that the second device shares a capability with the first device.

10. The method of claim 9, further comprising:
after detecting the polarity inversion, detecting a polarity reversion of the wired connection, wherein determining that the second device shares the capability with the first device is also based on detecting the polarity reversion.

11. The method of claim 10, further comprising:
after detecting the polarity reversion, receiving an acknowledgement message corresponding to the request.

12. The method of claim 11, wherein the acknowledgement message is received within a threshold amount of time from sending the request.

13. The method of claim 9, further comprising:
after determining that the second device shares the capability with the first device, performing an operation corresponding to the capability.

14. The method of claim 9, wherein the capability is a link training process that enhances a block error rate (BLER) of data transmitted between the first and second devices.

15. A method of operating a first device, the method comprising:
receiving a request from a second device over a wired connection; and
inverting a polarity of the wired connection based on the request.

16. The method of claim 15, further comprising:
after inverting the polarity of the wired connection, reverting the polarity of the wired connection based on the request.

17. The method of claim 16, wherein inverting the polarity of the wired connection is based on an expiration of a timer.

18. The method of claim 16, further comprising:
after reverting the polarity of the wired connection, detecting a polarity inversion and a polarity reversion of the wired connection; and
determining, based on detecting the polarity inversion and the polarity reversion of the wired connection, that the second device shares a capability with the first device.

19. The method of claim 15, further comprising:
after inverting the polarity of the wired connection, sending an acknowledgement message corresponding to the request.

20. The method of claim 19, wherein the acknowledgement message is sent within a threshold amount of time from receiving the request.
